(19) United States
(12) Patent Application Publication
(10) Pub. No.: US 2011/0285918 A1
(43) Pub. Date: Nov. 24, 2011

(54) Television Antenna System that can Read and Play Multimedia Video and Audio Information

(76) Inventor: Ming-Wen Chang, Tainan (TW)

(21) Appl. No.: 12/785,680

(22) Filed: May 24, 2010

(51) Int. Cl. H04N 5/40

(52) U.S. Cl. 348/724; 348/E05.094

(57) ABSTRACT

A television antenna system includes a box-shaped television antenna receiver, an antenna mounted in the television antenna receiver and connected with a television to transmit television signals to the television, a multimedia interface mounted in the television antenna receiver, and a RF modulator mounted in the television antenna receiver and connected between the multimedia interface and the television to transmit audio/video signals from the multimedia interface to the television. Thus, the multimedia interface is connected with the television through the RF modulator. When in use, the television co-operates with the television antenna system to play the audio/video signals of an external multimedia equipment by operation of the multimedia interface, so that the external multimedia information is directly played in the television without having to be played in the computer.

### BACKGROUND OF THE INVENTION

1. Field of the Invention

The present invention relates to an antenna system and, more particularly, to a television antenna system that can read and play multimedia video and audio information.

2. Description of the Related Art

A conventional television antenna system comprises an antenna connected with a television, and an amplifier connected between the antenna and the television. Thus, after the antenna receives the television signals, the television signals of the antenna is amplified by the amplifier and is transmitted to the television so that the television can play the television signals from the antenna, and the user can watch the VHF/UHF programs in the television by operation of the antenna. However, the television cannot play the audio/video signals of an external multimedia equipment, such as a CD, VCD, DVD, MP4 and the like, so that the external multimedia information has to be played in the computer, thereby causing inconvenience to the user, and thereby decreasing the versatility of the television.

### BRIEF SUMMARY OF THE INVENTION

In accordance with one embodiment of the present invention, there is provided a television antenna system, comprising a box-shaped television antenna receiver, an antenna mounted in the television antenna receiver and connected with a television to transmit television signals to the television, a multimedia interface mounted in the television antenna receiver, and a RF modulator mounted in the television antenna receiver and connected between the multimedia interface and the television to transmit audio/video signals from the multimedia interface to the television. Thus, the multimedia interface is connected with the television through the RF modulator.

In accordance with another embodiment of the present invention, the RF modulator is removed from the television antenna receiver, and the multimedia interface is directly connected with the television by connecting cords.

The primary objective of the present invention is to provide a television antenna system that can read and play multimedia video and audio information.

According to the primary advantage of the present invention, the television co-operates with the television antenna system to play the audio/video signals of an external multimedia equipment by operation of the multimedia interface of the television antenna system, so that the external multimedia information is directly played in the television without having to be played in the computer to facilitate the user playing the external multimedia information.

According to another advantage of the present invention, the television can play the television signals from the antenna and can also play the audio/video signals of the multimedia interface by switching of the switching device so that the television has multiple functions to enhance the versatility of the television.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a television antenna receiver of a television antenna system in accordance with the preferred embodiment of the present invention.

FIG. 2 is a rear perspective view of the television antenna receiver of the television antenna system as shown in FIG. 1.

FIG. 3 is a block view of a multimedia interface of the television antenna system as shown in FIG. 1.

FIG. 4 is a front view of a RF modulator of the television antenna system as shown in FIG. 1.

FIG. 5 is a block view of the television antenna system as shown in FIG. 1.

FIG. 6 is a rear perspective view of a television antenna receiver of a television antenna system in accordance with another preferred embodiment of the present invention.

### DETAILED DESCRIPTION OF THE INVENTION

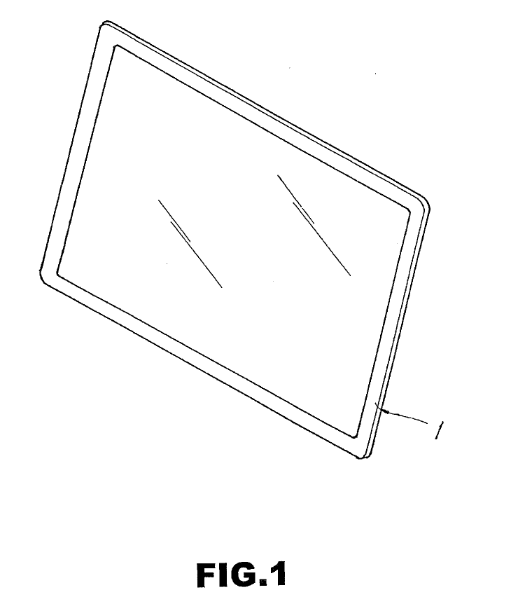

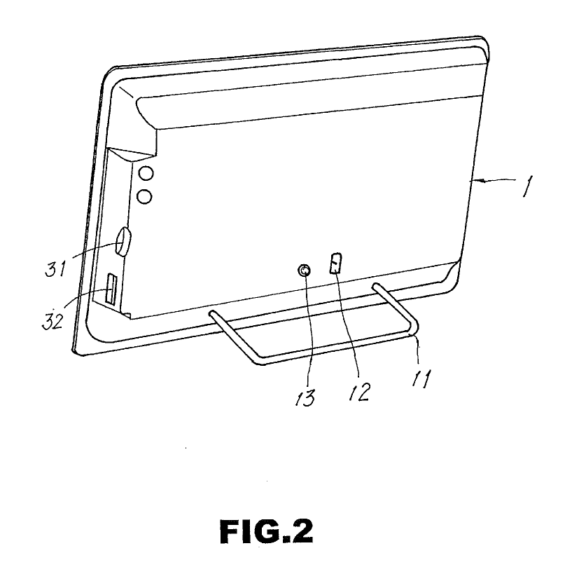

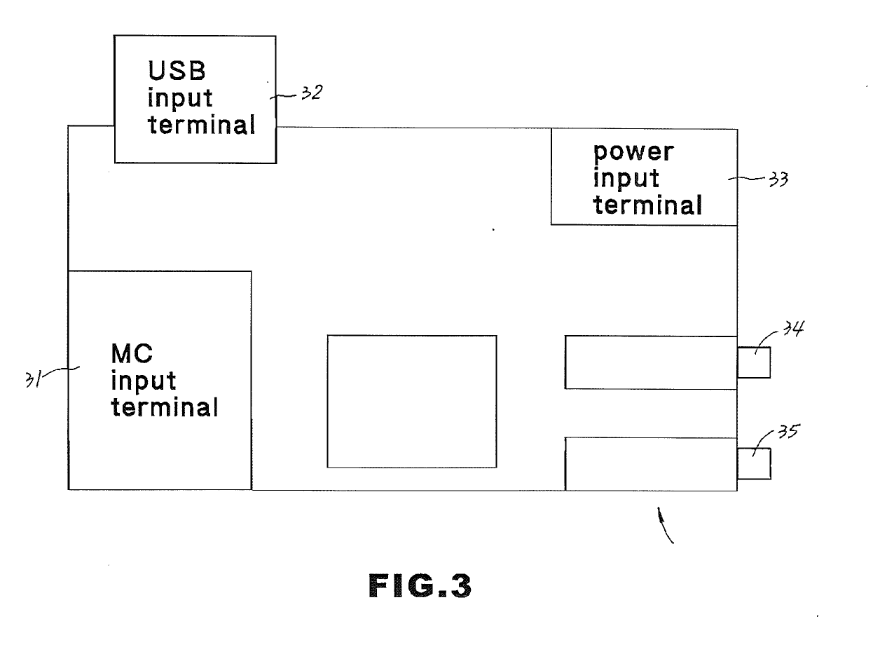

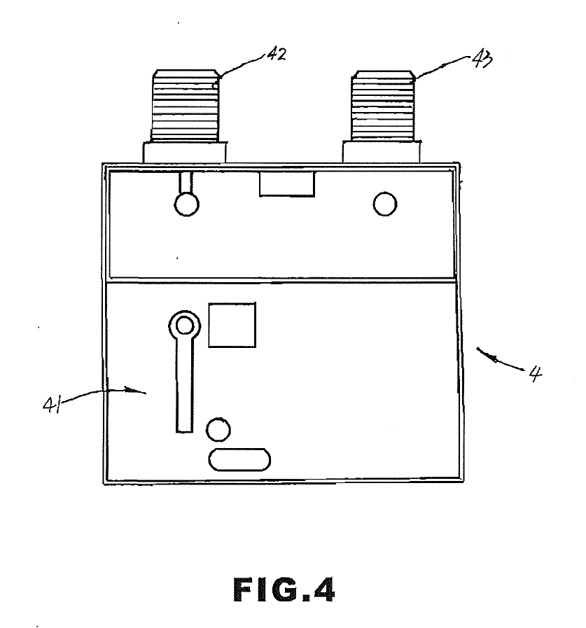

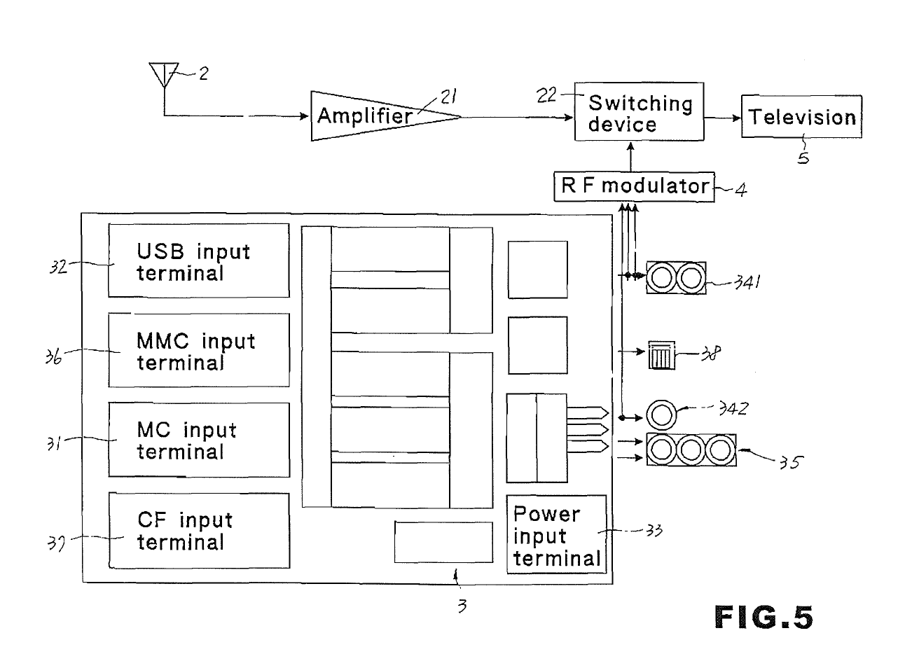

Referring to the drawings and initially to FIGS. 1-5, a television antenna system in accordance with the preferred embodiment of the present invention comprises a box-shaped television antenna receiver 1, an antenna 2 mounted in the television antenna receiver 1 and connected with a television 5 to transmit television signals (including VHF/UHF signals) to the television 5, a multimedia interface 3 mounted in the television antenna receiver 1, and a RF modulator 4 mounted in the television antenna receiver 1 and connected between the multimedia interface 3 and the television 5 to transmit audio/video signals from the multimedia interface 3 to the television 5.

The television antenna receiver 1 has a bottom provided with a support bracket 11 to support the television antenna receiver 1 in an upright manner. The television antenna receiver 1 has a rear portion provided with a power supply connector 12 and a coaxial cable connector 13 for connection with the television 5.

The antenna 2 is connected with an amplifier 21 which is connected with a switching device 22 which is connected with the television 5.

The multimedia interface 3 includes a MC (memory card) input terminal 31, a USB (universal serial bus) input terminal 32, a power input terminal 33, an A/V (audio/video) output terminal 34, a MMC (multimedia card) input terminal 36, a CF input terminal 37 and a TOSLINK connector 38. The MC input terminal 31 and the USB input terminal 32 of the multimedia interface 3 are mounted on and exposed from a side of the television antenna receiver 1. The power input terminal 33 of the multimedia interface 3 is connected with the power supply connector 12 of the television antenna receiver 1.

The RF modulator 4 includes an A/V and power input terminal 41, an antenna input terminal 42 and a connector 43. The A/V and power input terminal 41 of the RF modulator 4 is connected with the A/V output terminal 34 of the multimedia interface 3. The antenna input terminal 42 of the RF modulator 4 is connected with the antenna 2. The connector 43 of the RF modulator 4 is connected with the switching device 22. Thus, the multimedia interface 3 is connected with the RF modulator 4 by connection of the A/V output terminal 34 with the A/V and power input terminal 41, and the RF modulator 4 is connected with the television 5 through the switching device 22 so that the multimedia interface 3 is connected with the television 5 through the RF modulator 4.

In practice, after the antenna 2 receives the television signals, the television signals of the antenna 2 is amplified by the amplifier 21 and is transmitted through the switching device 22 to the television 5 so that the television 5 can play the television signals from the antenna 2 by switching of the switching device 22. At the same time, the multimedia interface 3 is connected with the television 5 through the RF modulator 4, so that the audio/video signals of the multimedia interface 3 is transmitted through the A/V output terminal 34, the RF modulator 4 and the switching device 22 to the television 5, and the television 5 can play the audio/video signals of the multimedia interface 3 by switching of the switching device 22.

When in use, the television 5 can play the television signals from the antenna 2 by switching of the switching device 22 so that the user can watch the VHF/UHF programs in the television 5 by operation of the antenna 2. In addition, when the audio/video signals are transmitted through the MC input terminal 31, the USB input terminal 32, the MMC input terminal 36 and the CF input terminal 37 into the multimedia interface 3, the audio/video signals of the multimedia interface 3 are transmitted through the RF modulator 4 to the television 5 so that the television 5 can play the audio/video signals of the multimedia interface 3 by switching of the switching device 22, and the user can watch the audio/video signals from the multimedia interface 3. Thus, the television 5 functions as a digital frame by provision of the multimedia interface 3 to replace the computer so that the external audio/video signals are directly played in the television 5 by operation of the multimedia interface 3 without having to be played in the computer to facilitate the user playing the external audio/video signals.

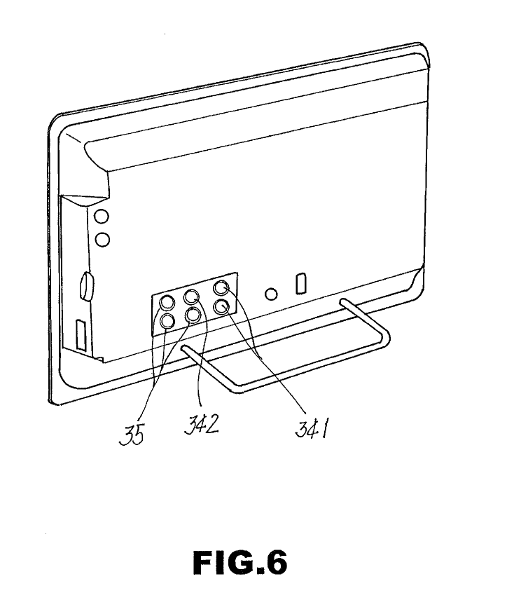

As shown in FIG. 6, the RF modulator 4 is removed from the television antenna receiver 1. The A/V output terminal 34 of the multimedia interface 3 is additionally provided with an audio L/R output terminal 341 and a video output terminal 342. The multimedia interface 3 further includes a YPbPr output terminal 35. In such a manner, the audio L/R output terminal 341, the video output terminal 342 and the YPbPr output terminal 35 of the multimedia interface 3 are mounted on and exposed from the rear portion of the television antenna receiver 1 and are respectively connected with input terminals of the television 5 by connecting cords. Thus, the multimedia interface 3 is directly connected with the television 5 without needing aid of the RF modulator 4.

Accordingly, the television 5 co-operates with the television antenna system to play the audio/video signals of an external multimedia equipment, such as a CD, VCD, DVD, MP4 and the like, by operation of the multimedia interface 3 of the television antenna system, so that the external multimedia information is directly played in the television 5 without having to be played in the computer to facilitate the user playing the external multimedia information. In addition, the television 5 can play the television signals from the antenna 2 and can also play the audio/video signals of the multimedia interface 3 by switching of the switching device 22 so that the television 5 has multiple functions to enhance the versatility of the television 5.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A television antenna system, comprising:
a box-shaped television antenna receiver;
an antenna mounted in the television antenna receiver and connected with a television to transmit television signals to the television;
a multimedia interface mounted in the television antenna receiver; and
a RF modulator mounted in the television antenna receiver and connected between the multimedia interface and the television to transmit audio/video signals from the multimedia interface to the television.

2. The television antenna system of claim 1, wherein the multimedia interface is connected with the television through the RF modulator.

3. The television antenna system of claim 1, wherein
the RF modulator is removed from the television antenna receiver; and
the multimedia interface is directly connected with the television by connecting cords.
